(19) United States
(12) Patent Application Publication
(10) Pub. No.: US 2006/0261137 A1
(43) Pub. Date: Nov. 23, 2006

(54) Dissimilar metal joint member with good corrosion resistance and method for manufacturing same

(75) Inventors: Hidekazu Ido, Kobe-shi (JP); Mikako Takeda, Kobe-shi (JP); Wataru Urushihara, Kobe-shi (JP); Jun Katoh, Kobe-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/130,139

(22) Filed: May 17, 2005

(51) Int. Cl. C04B 9/02; B23K 1/20

(52) U.S. Cl. 228/214; 228/262.4; 228/262.5

(57) ABSTRACT

A method for manufacturing a dissimilar metal joint member having an excellent corrosion resistance is provided. The method comprises immersing a member having an iron material and Al or an Al alloy material jointed together in a solution containing fluoro complex ions and zinc ions to cause metallic zinc to be deposited in the vicinity of a jointed portion.

### BACKGROUND OF THE INVENTION

1. Field of the Invention

This invention relates to a member having an excellent bimetallic corrosion resistance used at an aluminium-copper dissimilar metal joint portion employed such as in automobiles and the like.

2. Related Art

It is known in the art that when using dissimilar metals in combination at a joint of members of automobiles and the like, the metals are in mutual contact with each other to allow electric conduction therebetween, thereby promoting corrosion.

Such bimetallic corrosion as mentioned above occurs in such a way that a potential difference is caused between the metals due to the difference in ionization tendency therebetween, thereby causing a corrosion current to pass. To avoid the bimetallic corrosion, the following countermeasures are conventionally known.

(1) Prior art 1 (Japanese Laid-open Patent Application No. Sho 55-6411 and the like)

Where a metal indicating a less noble potential and a metal indicating a more noble potential are brought into contact with each other, a metal exhibiting an intermediate potential is sprayed onto a metal side indicating the less noble potential. The metal spraying may be effected on either of the less noble and more noble metals or both thereof. In this way, the potential difference between both metals can be lessened, thus enabling one to reduce electrolytic corrosion of the metal of the less noble potential.

(2) Prior art 2 (Japanese Laid-open Patent Application No. Sho 60-58272 and the like)

A paint having selective anion transmission action is undercoated on a surface of a metal, selected from two types of metals in contact with each other in an aqueous solution, on which an anode is formed. Thereafter, a paint having selective cation transmission action may be overcoated, or a cationic exchange film may be bonded with the under coating paint to cover the undercoating therewith. Alternatively, an ionic exchange composite film may be bonded by means of an undercoating paint as used above such that a pain having cation transmission action is undercoated on a metal surface where a cathode is formed and another type of paint having selective anion transmission action is overcoated, or ionic electrophoresis between metals may be interrupted by other technique to prevent bimetallic corrosion.

(3) Prior art 3 (Japanese Laid-open Patent Application No. Sho 61-23777 and the like)

Terminals are attached to different types of metal materials, between which a DC voltage is applied so as to prevent the metal materials from being ionized, thereby inhibiting the occurrence of electrolytic corrosion.

(4) Prior art 4 (Japanese Patent Publication No. 54-28941)

A conductive pain containing a large amount of a metal which is less noble than aluminium is applied onto metal surfaces of a relay box and an anchor housing.

(5) Prior art 5 (Japanese Patent Publication No. 59-37753 and the like)

When Cr is plated on surfaces of metals such as Cu, Cu—Zn alloys and Ni, a counterpart metal material of dissimilar metal materials contacting with each other, such as a Zn alloy, Fe, Al or the like, i.e. a less-noble metal material, is reduced in corrosion weight loss.

(6) Prior art 6 (Japanese Laid-open Patent Application No. Hei 5-222557 and the like)

A different type of metal is plated on both sides of a sheet made of a metal having an ionization tendency larger than iron to provide an anticorrosive sheet which has a natural electrode potential difference from a steel sheet at 0 to −300 mV. This anticorrosive sheet is sandwiched between two jointing sheets of steel thereby forming an anticorrosive layer.

(7) Prior art 7 (Japanese Laid-open Patent Application No. Hei 7-252679 and the like)

A body made of a different type of metal in contact with an aluminium alloy is plated with a zinc/cobalt alloy having a cobalt content of 1 to 5 wt % based on the alloy plating.

(8) Prior art 8 (Japanese Laid-open Patent Application No. Hei 9-157870 and the like)

In a structure where an aluminium alloy casting having stress corrosion susceptibility and a steel member of a different type of metal come into contact with each other under a stress load, a method of preventing stress corrosion with the aluminium alloy casting is provided. More particularly, this method is to prevent stress corrosion of the aluminium alloy casting by interposing, at least a part of an area of contact between the casting and the steel member, a metal member or metal layer which is less noble by 100 mV vs SCE or over or is more noble by −1500 mV vs SCE in terms of mixed potential than the natural potential of the casting.

As will be apparent from the above, a variety of methods of preventing bimetallic corrosion have been proposed. Assuming practical application to joint or jointing members, these prior art techniques have the following problems. More particularly, with the prior art 1, use of metal spraying involves a difficulty in application to members of complicated profiles. The prior arts 2, 4 and 8 involve a difficulty in coating a joint at a very near proximity or slit thereof. With the prior art 3, it would be difficult to stably apply, in transport airplanes or building materials, a DC voltage after provision of terminals at metal materials. With the prior art 5 where Cr plating is effected on noble metals, limitation is placed on a size of a member to be applied, in addition, there also might be an environmental problem of chromium-pollution. With the prior art 6, inserting a sheet plated with a different type of metal at a joint is very difficult from a standpoint of fabrication, with the possibility that the sheet may be lost upon application of heat used for jointing. Where the technique of the prior art 7 is applied to a joint member, the plated metal at the joint portion is removed by melting, with a reduced effect being expected.

### SUMMARY OF THE INVENTION

It is accordingly an object of the invention to provide a member made of an iron material and aluminium or an aluminium alloy material jointed together by practically suitable means thereby imparting excellent corrosion resistance thereto.

In order to achieve the above object, we contemplate to provide the following methods.

(1) A method for manufacturing a dissimilar metal joint member having an excellent corrosion resistance, which comprises immersing a member made of an iron material and aluminium or an aluminium alloy material jointed together in a solution containing fluoro complex ions and zinc ions so that metallic zinc is deposited in the vicinity of the jointed portion.

(2) The method as recited in (1) above, wherein the fluoro complex ions consist of hexafluorosilicate ions or tetrafluoroborate ions.

(3) The method as recited in (1) or (2), wherein concentrations of the fluoro complex ions and zinc ions are, respectively, at 2 mmols/L or over.

(4) A dissimilar metal joint member having an excellent corrosion resistance comprising an iron material and aluminium or an aluminium alloy material jointed together, and metallic zinc existing in the vicinity of a joint at a joint face side of the iron material.

(5) The dissimilar metal joint member as recited in (4) above, wherein the metallic zinc is made of a deposited one.

(6) The dissimilar metal joint member as recited in (4), wherein the metallic zinc is deposited by immersion of the joint member in a solution containing fluoro complex ions and zinc ions.

According to the invention, metallic zinc is caused to exist, as deposited, in the vicinity of a jointed portion of an iron material that is electrochemically more noble than aluminium, and aluminium or an aluminium alloy material, so that a resistance to bimetallic corrosion can be reliably improved.

### BRIEF DESCRIPTION OF THE DRAWINGS

FIG. 1 is a schematic view showing a deposited state of metallic zinc and a mechanism of suppressing corrosion in the vicinity of a joint portion (i.e. a joint-affecting portion) of an aluminium-iron joint member according to the invention; and

FIG. 2 is a schematic view showing a mechanism of promoting corrosion in the vicinity of a joint portion (i.e. joint-affecting portion) of an aluminium-iron joint member.

### DETAILED DESCRIPTION OF THE PREFERRD EMBODIMENTS

When members of aluminium or an aluminium alloy material (hereinafter referred to as an aluminium material or merely as aluminium) and iron, steel or an iron alloy (hereinafter referred to as an iron material or merely as iron) are jointed, it is usual that aluminium (Al) that is a metal less noble than iron (Fe) is converted to Al³⁺ ions and dissolved out, thereby promoting corrosion. This is because a corrosion current flows between both materials due to a great potential difference between aluminium and iron.

In order to prevent the promotion of the corrosion, it would occur that such a great potential difference is lessened by the existence of a metal having an ionization tendency intermediate between aluminium and iron at the dissimilar metal joint-affecting portion. The previously stated prior art techniques also make use of such a principle as mentioned above so as to suppress contact corrosion.

However, the prior art techniques have such problems as set out hereinbefore in practice. Especially, a difficulty is involved in permitting a metal having an intermediate ionization tendency to sufficiently exist in the closest vicinity of the joint portion or at a small interstice. This is why such techniques have never been put into practice.

Under these circumstances in the art, we made intensive and continuous experimental efforts and studies and, as a result, found that when an aluminium and iron joint member is immersed in a solution containing fluoro complex ions and zinc ions to permit dense, strong and adhesive metallic zinc to reliably exist in the vicinity of the joint portion. The metallic zinc has an ionization tendency intermediate between aluminium and iron, so that the joint member shows an excellent resistance to bimetallic corrosion.

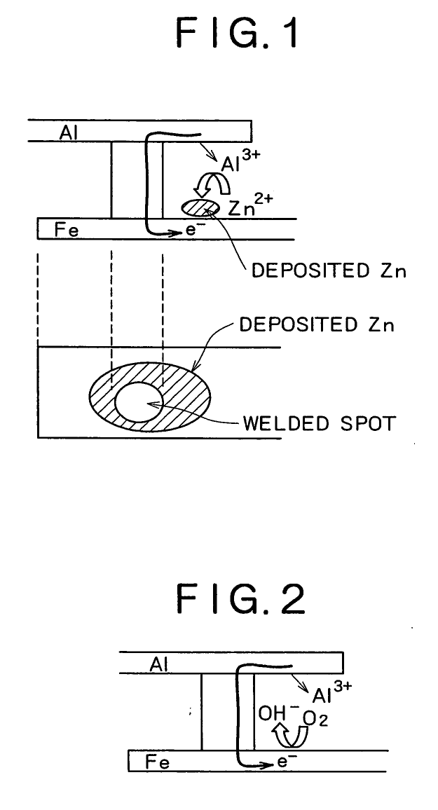

According to this method of immersing a joint body in a solution containing fluoro complex ions and zinc ions, the potential difference between both materials is used to cause the following reaction
2Al+3Zn²⁺→2Al³⁺+3Zn
to proceed at a site or portion which suffers an influence of potential difference resulting from dissimilar metal joint in the vicinity of the joint portion. Eventually, as shown in FIG. 1, metallic zinc can be deposited on and attached to the surface of the iron at this site, thereby causing the zinc to exist thereat. This zinc is formed by deposition, and thus, can be reliably and satisfactorily attached to the iron surface in the vicinity of the joint portion even if the joint portion is very narrow. In addition, the deposited layer of iron is dense and high in adhesion and is thus unlikely to disappear through peeling-off or breakage and can be held as attached over a long time. As a consequence, the influence of potential difference is mitigated, thereby ensuring effective suppression of corrosion.

Further, fluoro complex ions are able to dissolve an oxide film on an aluminium surface and thus, serves to cause the above reaction to proceed smoothly.

The salts containing fluoro complex ions include, for example, a hexafluorosilicate, tetrafluoroborate, hexafluorophosphate, and fluorosulfate. In view of the stability and reactivity, it is preferred to use a hexafluorosilicate or a tetrafluoroborate.

The treating time should preferably be within a range of 30 seconds to 3 minutes from the standpoint of ensuring corrosion resistance of joint member and productivity. The treating time is preferably not lower than 40° C. in view of the reactivity and the ease in temperature control and not higher than 80° C. in view of suppressing evaporation of treating solution.

It will be noted that the vicinity of joint member means a portion interposed between members in ordinary cases, for which that portion cannot be treated by other methods such as electroplating, metal spraying and the like.

The invention is more particularly described by way of example.

### EXAMPLE

1. Testing Method

(1) Spot Welding

A mild steel plate (30×100×0.8 mm) and each of aluminium plates (6022 and 5023 with a dimension of 30×100×0.8 mm) were spot welded under conditions of 12 kV and 200 ms.

(2) Treatment with Zinc Salt

Immersed in solutions indicated in Table 1 at 60° C. for 30 to 129 seconds.

(3) Chemical Conversion Treatment

Treating procedure: treating in the order of (a) degreasing→(b) rinsing with water→(c) surface adjustment→(d) chemical conversion (dipping)→(e) drying after chemical conversion→(f) rinsing with water→(g) rinsing with pure water→(h) drying by drainage→(i) painting.
(a) Degreasing: using an aqueous solution of 1.5 wt % of “A” agent and 0.9 wt % of “B” agent of an alkaline degreasing agent (commercially available from Nippon Paint Co., Ltd., with a commercial name of “Surf Cleaner SD250”) for immersion at 43° C. for 2 minutes.
(b) Rinsing with water: immersed in city water at room temperature for 15 seconds.
(c) Surface adjustment: using an aqueous solution of 0.1 wt % of a surface adjuster (commercially available from with a commercial name of “Surf Fine 5N-10” for bathing for immersion of a target metal at room temperature for 30 seconds.
(d) Chemical conversion: carried out by immersing a member to be treated in a bath of the following zinc phosphate treating agent at 50° C. for 2 minutes.

Zinc ion: 1 g/liter, nickel ion: 1.0 g/liter, manganese ion: 0.8 g/liter, phosphate ion: 15.0 g/liter, nitrate ion: 6.0 g/liter, nitrite ion: 0.12 g/liter Toner value: 2.5 pts, total acidity: 22 pts, free acidity: 0.3 to 0.5 pts

(4) Electrodeposition Painting

A cationic electrodeposition paint (commercially available from Nippon Paint Co., Ltd., with a commercial name of “Power Top V50 Gray”) was pained by cationic electrodeposition painting and baked at a temperature of 170° C. for 25 minutes to form a 30 μm thick pain film.

(5) Composite Corrosion Test (CCT)

Test pieces made in (1) to (4) above were subjected to a composite corrosion test to evaluate bimetallic corrosion resistance. The corrosion test was conducted by repeating 100 times a cycle test having each cycle of 2 hours salt spraying, 2 hours drying and 2 hours wetting. Thereafter, the joint portion was peeled off and observed to assess corrosion resistivity (a maximum depth of corrosion of Al).

2. Results

The results of the assessment of the corrosion resistivity and chemical conversion are shown in Tale 1. The corrosion resistivity was evaluated by measuring a maximum depth of corrosion of Al (mm) and ranking according to the following three phases: ◯: 0 to 0.01 (mm), Δ: 0.01 to 0.1 (mm), and X: larger than 0.1 (mm). The chemical conversion was evaluated by measuring an amount of deposited film and ranking according to the following three phases: ◯: 1 to 2 (g/m²), Δ: 0.5 to 1 (g/m²), and X: 0 to 0.5 (g/m²).

From the table, it will be seen that the inventive examples 1 to 9 are excellent in both chemical conversion property and corrosion resistivity. On the other hand, with Comparative Example 10, because of the low reactivity of fluoro complex ions, the effect is unsatisfactory.

Although aluminium and ion have been stated with respect to dissimilar metal joint member in the foregoing illustration, the invention is also applicable to for improving a corrosion resistance of members jointing a metal more noble in ionization tendency than zinc and a less noble metal.

TABLE 1

| | | | Fluoro | Treating | Component In | | Chemical | Corrosion | |
|---|---|---|---|---|---|---|---|---|---|
| | Type | Zn ion | Complex Ion | Time | Treating Solution | | Conversion | Resistance | |
| No. | of Al | (mmols/ Liter) | (mmols/ Liter) | (seconds) | [Concentration (g/Liter)] | | Property of Al | of Al | Remarks |
| 1 | 6022 | 2.5 | 2.5 | 30 | ZnSiF₆ | 0.5 | ∘ | ∘ | Inventive Example |
| 2 | 6022 | 22 | 22 | 30 | ZnSiF₆ | 4.5 | ∘ | ∘ | Inventive Example |
| 3 | 6022 | 4 | 8 | 30 | Zn(BF₄)₂ | 1 | ∘ | ∘ | Inventive Example |
| 4 | 6022 | 19 | 38 | 30 | Zn(BF₄)₂ | 4.5 | ∘ | ∘ | Inventive Example |
| 5 | 6022 | 27 | 27 | 30 | ZnSiF₆ | 5.5 | ∘ | ∘ | Inventive Example |
| 6 | 6022 | 23 | 46 | 30 | Zn(BF₄)₂ | 5.5 | ∘ | ∘ | Inventive Example |
| 7 | 5023 | 27 | 27 | 30 | ZnSiF₆ | 5.5 | ∘ | ∘ | Inventive Example |
| 8 | 6022 | 0.4 | 0.8 | 120 | Zn(BF₄)₂ | 0.1 | ∘ | ∘ | Inventive Example |
| 9 | 6022 | 1 | 1 | 60 | ZnSiF₆ | 0.2 | ∘ | ∘ | Inventive Example |
| 10 | 6022 | 30 | 30 | 60 | ZnSO₄F | 5.5 | Δ | x | Comparative Example |

What is claimed is:

1. A method for manufacturing a dissimilar metal joint member having an excellent corrosion resistance, which comprises immersing a member made of an iron material and aluminium or an aluminium alloy material jointed together in a solution containing fluoro complex ions and zinc ions so that metallic zinc is deposited in the vicinity of the jointed portion.

2. The method according to claim 1, wherein the fluoro complex ions consist of hexafluorosilicate ions or tetrafluoroborate ions.

3. The method according to claim 1 or 2, wherein concentrations of the fluoro complex ions and zinc ions are, respectively, at 2 mmols/liter or over.

4. A dissimilar metal joint member having an excellent corrosion resistance comprising an iron material and aluminium or an aluminium alloy material jointed together, and metallic zinc existing in the vicinity of a joint at a joint face side of the iron material.

5. The dissimilar metal joint member according to claim 4, wherein said metallic zinc is made of a deposited one.

6. The dissimilar metal joint member according to claim 4, wherein said metallic zinc is deposited by immersion of the joint member in a solution containing fluoro complex ions and zinc ions.
